(19) United States
(12) Patent Application Publication
(10) Pub. No.: US 2009/0147402 A1
(43) Pub. Date: Jun. 11, 2009

(54) PATTERNED MAGNETIC RECORDING MEDIUM AND METHOD OF SELF SERVO WRITING ONTO THE SAME

(75) Inventors: Sang-chul SUL, Suwon-si (KR); Jun JEONG, Suwon-si (KR); Hyun-seok YANG, Seoul (KR); No-cheol PARK, Seoul (KR); Jin-seung SOHN, Seoul (KR); Hae-sung KIM, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/101,384

(22) Filed: Apr. 11, 2008

(30) Foreign Application Priority Data
Dec. 5, 2007 (KR) 10-2007-0125771

(51) Int. Cl. G11B 23/00

(52) U.S. Cl. 360/131

(57) ABSTRACT

Provided are a patterned magnetic recording medium and a method of self servo writing in which servo information is written on the patterned magnetic recording medium. The patterned magnetic recording medium includes: a data sector including a plurality of magnetic recording regions spaced apart from one another, wherein the magnetic recording regions constitute a plurality of tracks which are each shaped like a ring; and a servo sector on which servo information regarding the tracks is capable of being written along the tracks, wherein only to a part of the tracks of the servo sector, servo information regarding the part of the tracks is written in the form of a physical servo pattern which is formed by physically patterning a magnetic recording layer.

### CROSS-REFERENCE TO RELATED PATENT APPLICATION

This application claims priority from Korean Patent Application No. 10-2007-0125771, filed on Dec. 5, 2007 in the Korean Intellectual Property Office, the disclosure of which is incorporated herein in its entirety by reference.

### BACKGROUND OF THE INVENTION

1. Field of the Invention

The present invention relates to a patterned magnetic recording medium in which a data sector to which information is to be written is patterned, and a method of writing servo information onto the patterned magnetic recording medium.

2. Description of the Related Art

Hard disk drives (HDDs) that use magnetic recording media have a large recording capacity and a high access speed. As a result, they have received much attention for use as information memory apparatuses not only for computers but also for various other digital apparatuses. Recently, due to the widespread use of information systems, the amount of information exchanged over various networks has increased enormously. Thus, there is a need for high density HDDs to be developed.

As the recording density increases, the bit size, which is the minimum recording unit of data, has to be reduced, and accordingly, the intensity of magnetic signals generated from a recording medium is weakened. As a magnetic recording medium overcoming these problems and having the increased recording density, patterned magnetic recording media such as discrete track media or bit patterned media have been proposed, wherein a patterned magnetic recording medium includes a plurality of data sectors that are spaced apart from one another so that noise generated by a medium is reduced thereby maintaining a high signal to noise ratio (SNR).

Servo information needs to be previously written to a magnetic recording medium so that a magnetic head is correctly positioned at a desired position of the magnetic recording medium. In this regard, in a patterned magnetic recording medium in which data sectors are divided by grooves, the servo information is written in the form of a servo pattern having grooves. Generally, the grooves included in the servo pattern each have a greater width and are more densely formed than in the case of grooves used in the data sectors. Thus, flying of a slider including a head installed thereon cannot be stable, and there may exist a difference in flying heights when the slider flies. In addition, since the servo information is written in the form of the servo pattern including the grooves by using a bit combination including a signal “1” for a magnetized region and a signal “0” for a non-magnetized region, the patterned magnetic recording medium having the servo pattern has a lower reproducing output than in the case of a continuous magnetic recording medium having a servo pattern in which information is written using a bit combination including a signal “1” for a region magnetized in a predetermined direction and a signal “−1” for a region magnetized in a direction opposite to the predetermined direction.

### SUMMARY OF THE INVENTION

The present invention provides a patterned magnetic recording medium and a method of self servo writing onto the same.

According to an aspect of the present invention, there is provided a patterned magnetic recording medium comprising: a data sector including a plurality of magnetic recording regions spaced apart from one another, wherein the magnetic recording regions constitute a plurality of tracks which are each shaped like a ring; and a servo sector on which servo information regarding the tracks is capable of being written along the tracks, wherein only to a part of the tracks of the servo sector, servo information regarding the part of the tracks is written in the form of a physical servo pattern which is formed by physically patterning a magnetic recording layer.

A continuous magnetic recording layer may be formed on other tracks apart from the some tracks of the servo sector. Servo information regarding the other tracks may be written on the corresponding tracks of the servo sector.

One of the some tracks may comprise a track corresponding to a minimum absolute value of a skew angle of an HDD driving the patterned magnetic recording medium.

The patterned magnetic recording medium may be a discrete track medium in which the magnetic recording regions are discrete on a track by track basis. The patterned magnetic recording medium may be a bit patterned medium in which the magnetic recording regions are discrete on a bit by bit basis.

According to another aspect of the present invention, there is provided a method of self servo writing comprising: loading the patterned magnetic recording medium of claim 1 in an HDD, and moving a magnetic head to a reference position from which servo information written in the form of the physical servo pattern is capable of being read; and minutely moving the magnetic head, and writing servo information regarding other tracks apart from the part of tracks of the servo sector, on the corresponding tracks, on which the physical servo pattern is not formed, by using a reproducing signal generated from the physical servo pattern as a reference signal.

The minute moving of the magnetic head, may comprises: writing servo information regarding a first track, which is closest to the part of tracks of the servo sector, on the first track, by using the reproducing signal generated by using the physical servo pattern as a reference signal; and writing servo information regarding a second track, which is the closest to the first track, on the second track, by using a reproducing signal generated by using the servo information written on the first track as a reference signal.

If the skew angle may be in the range of a negative value to a positive value, the minute moving of the magnetic head, comprises: minutely moving the magnetic head in a direction in which a value of a skew angle is increased, and writing servo information regarding the other tracks on the corresponding tracks of the servo sector, on which the physical servo pattern is not formed; moving the magnetic head back to the reference position; and minutely moving the magnetic head in a direction in which a value of a skew angle is reduced, and writing servo information regarding the other tracks on the corresponding tracks of the servo sector, on which the physical servo pattern is not formed.

### BRIEF DESCRIPTION OF THE DRAWINGS

The above and other aspects of the present invention will become more apparent by describing in detail exemplary embodiments thereof with reference to the attached drawings in which:

FIG. 1 is a plan view of a patterned magnetic recording medium according to an exemplary embodiment of the present invention;

FIG. 2 is an enlarged perspective view an area A illustrated in FIG. 1, according to an exemplary embodiment of the present invention;

FIG. 3 is an enlarged perspective view of an area B illustrated in FIG. 1, according to an exemplary embodiment of the present invention;

FIG. 4 is a plan view of a patterned magnetic recording medium according to another exemplary embodiment of the present invention;

FIG. 5 is a plan view of a patterned magnetic recording medium according to another exemplary embodiment of the present invention;

FIG. 6 is an enlarged perspective view of an area A illustrated in FIG. 5, according to an exemplary embodiment of the present invention;

FIG. 7 is an enlarged perspective view of an area B illustrated in FIG. 5, according to an exemplary embodiment of the present invention;

FIG. 8 is a plan view of a patterned magnetic recording medium according to another exemplary embodiment of the present invention;

FIG. 9 is a block diagram of a hard disk drive (HDD) performing a method of self servo writing according to an exemplary embodiment of the present invention;

FIG. 10 is a flow chart of a method of self servo writing according to an exemplary embodiment of the present invention;

FIGS. 11A and 11B are diagrams for describing directions of servo writing according to skew angles when the method of self servo writing is performed, according to exemplary embodiments of the present invention.

### DETAILED DESCRIPTION OF EXEMPLARY EMBODIMENTS OF THE INVENTION

Hereinafter, the present invention will be described in detail by explaining exemplary embodiments of the invention with reference to the attached drawings. The same reference numerals in the drawings denote the same element. In the drawings, the thicknesses of layers and regions are exaggerated for clarity.

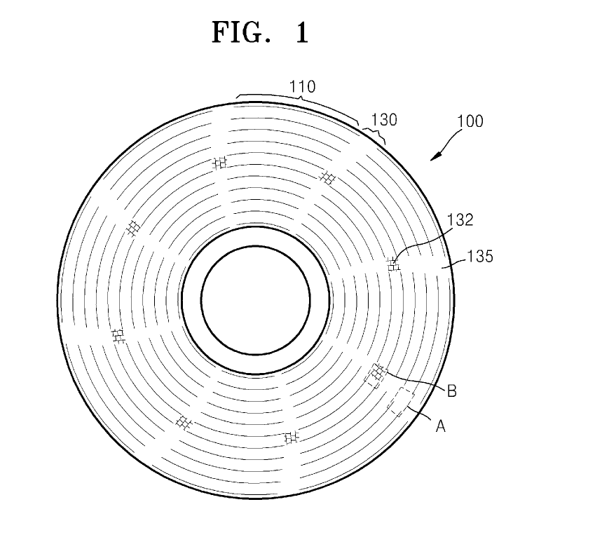

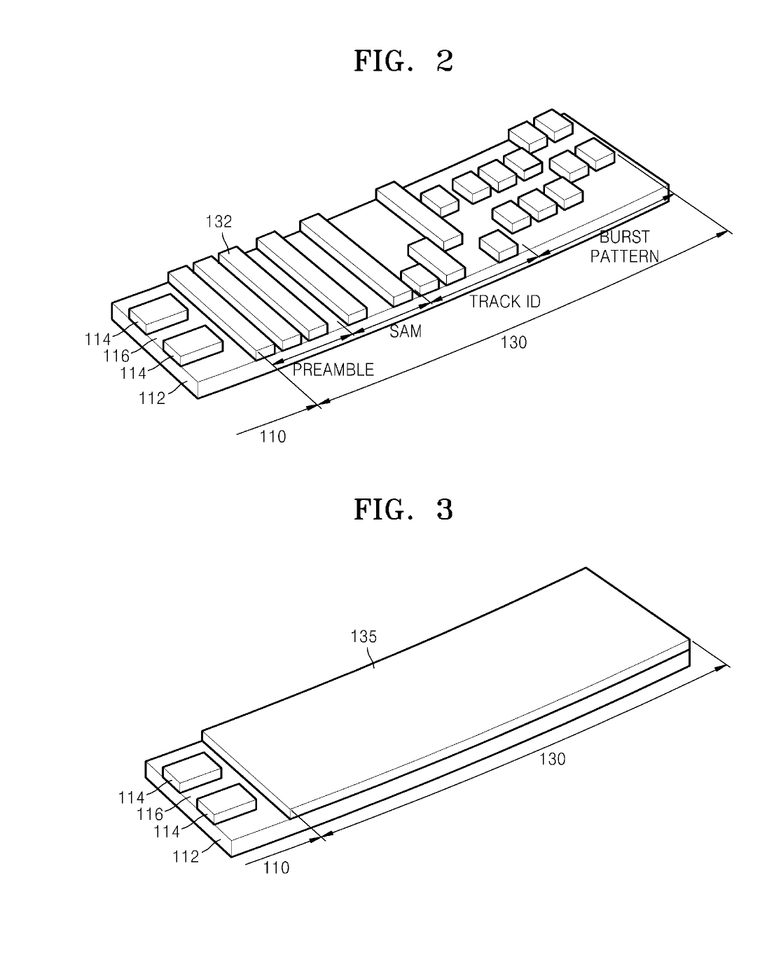

FIG. 1 is a plan view of a patterned magnetic recording medium 100 according to an exemplary embodiment of the present invention. FIGS. 2 and 3 are enlarged perspective views of areas A and B illustrated in FIG. 1, respectively, according to exemplary embodiments of the present invention.

Referring to FIGS. 1, 2 and 3, the patterned magnetic recording medium 100 includes a data sector 110 and a servo sector 130.

The data sector 110 includes a plurality of magnetic recording regions 114 spaced apart from one another on a substrate 112, wherein the magnetic recording regions 114 constitute a plurality of tracks which are each shaped like a ring. The magnetic recording regions 114 are spaced apart from one another only in a cross-track direction, i.e., in a direction crossing the tracks. Each of the magnetic recording regions 114 extend in a down-track direction, i.e., in a direction parallel to the tracks. Likewise, the patterned magnetic recording medium 100, in which the magnetic recording regions 114 are discrete on a track by track basis, is referred to as a discrete track medium. In FIGS. 1, 2 and 3, the magnetic recording regions 114 are spaced apart from one another by grooves 116, and nothing is in the grooves 116. However, the present invention is not limited thereto and the grooves 116 may be filled with a non-magnetic material.

The servo sector 130 is a region in which servo information regarding the tracks can be written along the tracks. The servo information is provided for seeking and following the tracks when the patterned magnetic recording medium 100 is driven on an HDD. In the patterned magnetic recording medium 100, servo information in the form of a physical servo pattern is written only to a part of the tracks of the servo sector 130. Here, the physical servo pattern denotes a servo pattern formed by physically patterning a magnetic recording layer 132 so as to have a predetermined pattern, and the servo information is contained in the physical servo pattern. For example, by magnetizing the patterned magnetic recording layer 132, the servo information can be written in the form of the physical servo pattern of the magnetic recording layer 132, by using a bit combination including a signal “1” for a magnetized region and a signal “0” for a non-magnetized region. For example, the physical servo pattern may include a preamble providing servo-synchronization, a servo address mark (SAM) signaling the beginning of the servo sector 130 and then providing synchronization for reading a gray code subsequent to the SAM, the gray code providing a track identification (ID), and a burst providing information for calculating a tracking error signal required for following the tracks, as illustrated in FIG. 2. However, the physical servo pattern illustrated in FIG. 2 is merely exemplary, and various changes in form and detail can be made. In addition, the physical servo pattern is formed over two tracks in FIG. 2, but this is just exemplary. That is, the physical servo pattern can be formed on any part of the tracks. For example, the physical servo pattern can be formed on one track or over three or more tracks. In addition, positions of the tracks where the physical servo pattern is formed are just exemplary, and are appropriately determined according to a skew angle of the HDD on which the patterned magnetic recording medium 100 is driven. For example, the physical servo pattern may be formed on a track including a position corresponding to a minimum absolute value of the skew angle. Thus, the physical servo pattern may be formed not only on the track illustrated in FIG. 1 but also on a track closer to an innermost track or an outermost track than the track illustrated in FIG. 1.

A continuous magnetic recording layer 135 is formed over all tracks of the servo sector 130 except for a part of the tracks on which the physical servo pattern is formed. Servo information regarding the respective tracks can also be written to a region on which the continuous magnetic recording layer 135 is formed. In a self servo writing method according to the present invention, servo information can be written to the continuous magnetic recording layer 135 by using the servo information written in the form of the physical servo pattern as a reference.

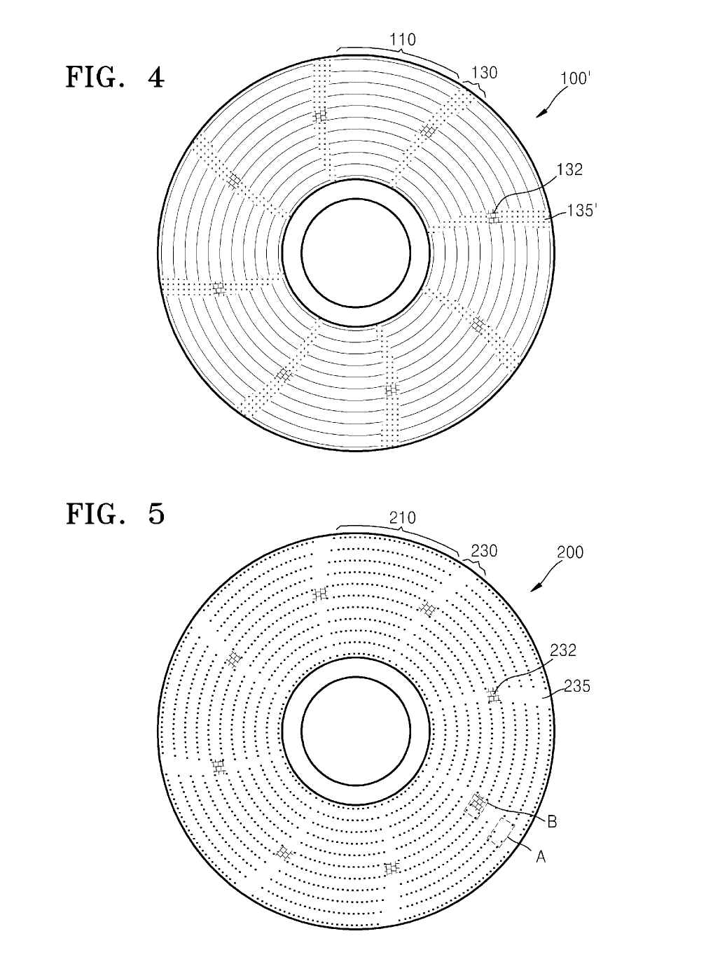

FIG. 4 is a plan view of a patterned magnetic recording medium 100′ according to another exemplary embodiment of the present invention. The patterned magnetic recording medium 100′ is the same as the patterned magnetic recording medium 100 of FIG. 1 except that servo information is written over all tracks of a servo sector 130. That is, a magnetic recording layer 132 is physically patterned on some tracks of the servo sector 130 thereby forming a physical servo pattern, and servo information, regarding the tracks on which the magnetic recording layer 132 is physically patterned, is written in the form of the physical servo pattern. In addition, servo information regarding the other tracks is written on the corresponding tracks of a magnetic recording layer 135′ in the form of a magnetic servo pattern. In this regard, the magnetic servo pattern is different from the physical servo pattern. Servo information is written in the form of the magnetic servo pattern of the magnetic recording layer 135′ by using a bit combination including a signal “1” for magnetization in a first direction in the continuous magnetic recording layer (see 135 of FIG. 3), and a signal “−1” for magnetization in a second direction opposite to the first direction.

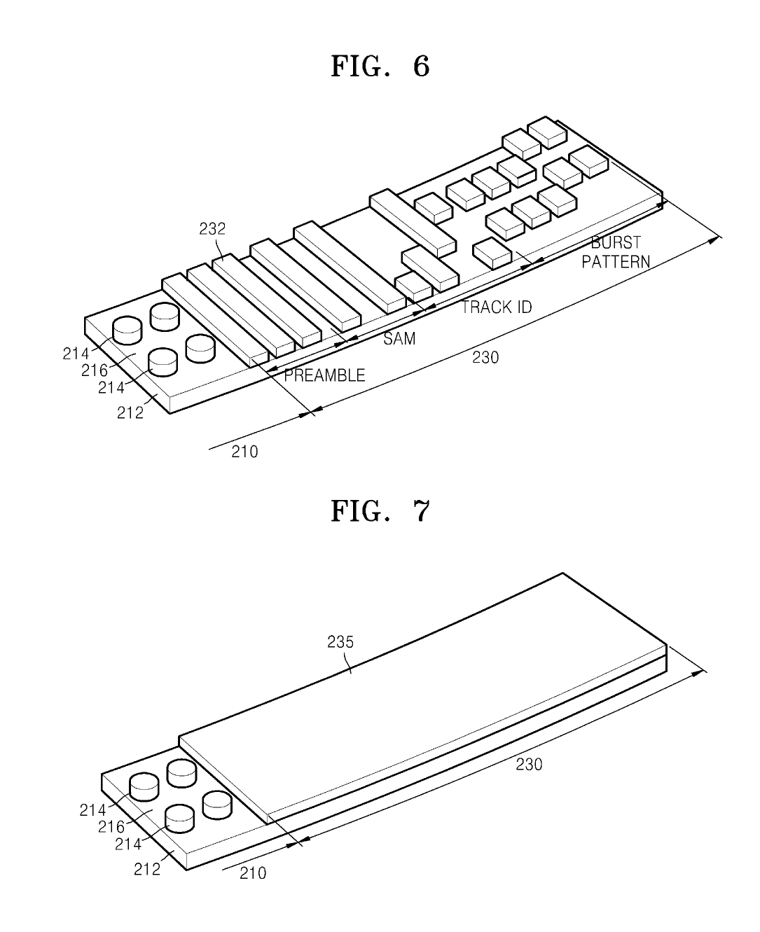

FIG. 5 is a plan view of a patterned magnetic recording medium 200 according to another exemplary embodiment of the present invention. FIGS. 6 and 7 are enlarged perspective views of areas A and B illustrated in FIG. 5, respectively, according to exemplary embodiments of the present invention.

Referring to FIGS. 5, 6 and 7, the patterned magnetic recording medium 200 includes a data sector 210 and a servo sector 230. In the current exemplary embodiment, the patterned magnetic recording medium 200 is the same as the patterned magnetic recording medium 100 of FIG. 1 except for the structure of the data sector 210. Thus, the patterned magnetic recording medium 200 will be described in terms of a difference between it and the patterned magnetic recording medium 100. Since the same reference numerals in diagrams denote the same element, descriptions of the same elements illustrated in FIGS. 1 through 3 will not be repeated here.

The data sector 210 includes a plurality of magnetic recording regions 214 spaced apart from one another by grooves 216 on a substrate 212, wherein the magnetic recording regions 214 constitutes a plurality of tracks which are each shaped like a ring. The magnetic recording regions 214 are spaced apart from one another in a cross-track direction and in a down-track direction on a bit by bit basis. Likewise, the patterned magnetic recording medium 200, in which the magnetic recording regions 214 are discrete on a bit by bit basis, is referred to as a bit patterned medium.

The servo sector 230 is a region to which servo information regarding the tracks can be written along the tracks. In the patterned magnetic recording medium 200 according to the current exemplary embodiment, servo information in a form of a physical servo pattern is written only on some tracks of the servo sector 230. In addition, a continuous magnetic recording layer 235 is formed over all tracks of the servo sector 230 except for the track on which the physical servo pattern is formed. Servo information regarding the respective tracks can also be written to a region on which the continuous magnetic recording layer 235 is formed.

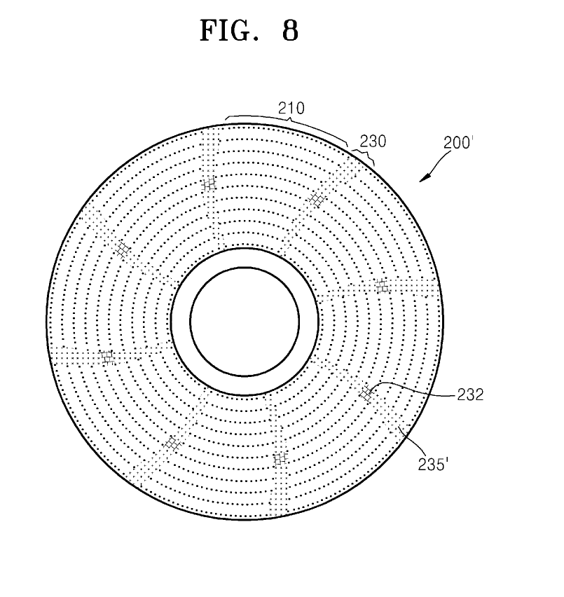

FIG. 8 is a plan view of a patterned magnetic recording medium 200′ according to another exemplary embodiment of the present invention. The patterned magnetic recording medium 200′ is the same as the patterned magnetic recording medium 200 of FIG. 5 except that servo information is written over all tracks of the servo sector 230. That is, a magnetic recording layer 232 is physically patterned on some tracks of the servo sector 230 thereby forming a physical servo pattern, and servo information, regarding the tracks on which the magnetic recording track 232 is physically patterned, is written in the form of the physical servo pattern. In addition, servo information regarding the other tracks is written on the corresponding tracks of a magnetic recording layer 235′ in the form of a magnetic servo pattern.

In the magnetic recording media 100 and 200 according to the above-described exemplary embodiments of the present invention, servo information regarding only some tracks of the servo sectors 130 and 230 is written in the form of the physical servo pattern. In addition, the continuous magnetic recording layers 135 and 235 to which servo information can be written are formed on the other tracks of the servo sectors 130 and 230. Thus, when the magnetic recording media 100 and 200 is loaded in an HDD, self-servo writing can be performed on the other tracks by using the physical servo pattern as a reference.

Also, the patterned magnetic recording media 100′ and 200′ according to the above-described exemplary embodiments of the present invention, servo information regarding only some tracks of the servo sectors 130 and 230 is written in the form of the physical servo pattern, and servo information regarding the other tracks is written in the form of the magnetic servo pattern of the continuous magnetic recording layer. Thus, a head slider has a good flying property when the head slider flies above the magnetic recording media 100′ and 200′ as compared with the case where the physical servo pattern is formed over all tracks of the servo sectors 130 and 230. In addition, the patterned magnetic recording media 100′ and 200′ can overcome a problem in terms of a low reproducing output of a physical servo pattern.

Hereinafter, a method of self servo writing according to an exemplary embodiment of the present invention will be described.

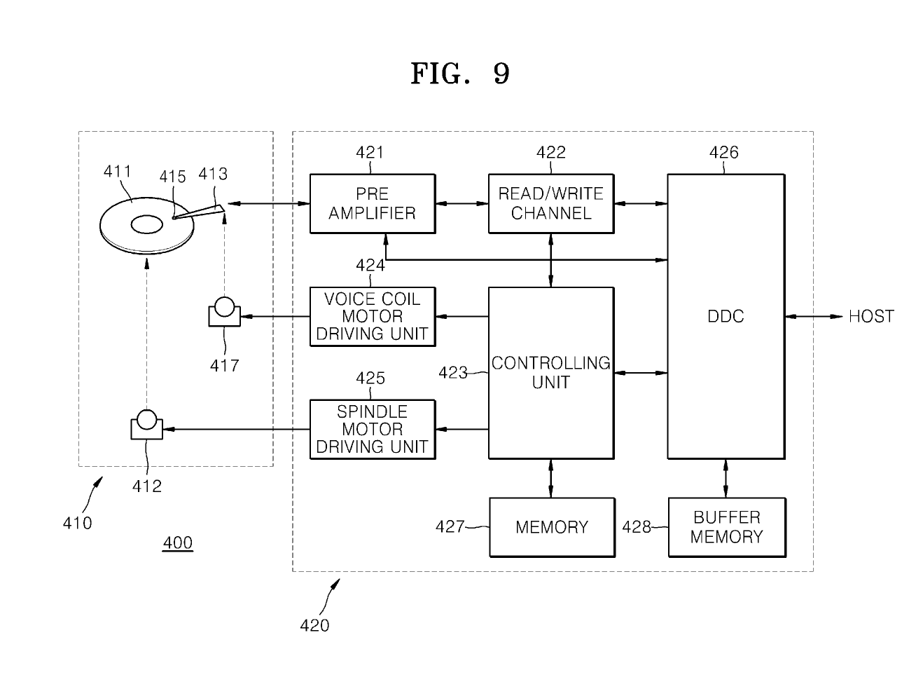

First, a schematic structure of an HDD 400 performing the method of self servo writing will be described with reference to FIG. 9. Referring to FIG. 9, the HDD 400 performing the method of self servo writing includes a head disk assembly 410 and a circuit unit 420.

The head disk assembly 410 includes a magnetic recording medium 411 and an actuator 413. The patterned magnetic recording medium (100 of FIG. 1, or 200 of FIG. 4) according to the above-described exemplary embodiments of the present invention can be used as the magnetic recording medium 411. The magnetic recording medium 411 is rotated by a spindle motor 412. The actuator 413 is driven by a voice coil motor (VCM) 417. A slider having a magnetic head 415 installed thereon is installed at an end of the actuator 413.

The circuit unit 120 includes a pre amplifier 421, a read/write channel 422, a controlling unit 423, a VCM driving unit 424, a spindle motor driving unit 425, a disk data controller (DDC) 426, a memory 427 and a buffer memory 428. When data is reproduced, the pre amplifier 421 applies an analog reproducing signal, which is formed by amplifying a signal picked up from the magnetic head 415, to the read/write channel 422. When data is recorded, coded recording data, which is applied from the read/write channel 422, is recorded via the magnetic head 415 onto a magnetic recording medium 411. The read/write channel 422 detects and decodes a data pulse from the reproducing signal applied from the pre amplifier 421, and then applies the data pulse to the DDC 426. In addition, the read/write channel 422 decodes the recording data applied from the DDC 426, and then applies the recording data to the pre amplifier 421. The DDC 426 functions as a communication interface between a host computer and the controlling unit 423. The buffer memory 428 is used for temporarily storing data transferred among the host computer, the controlling unit 423 and the read/write channel 422.

Servo information read from the magnetic head 415 is transferred via the pre amplifier 421 and the read/write channel 422 to the controlling unit 423. The controlling unit 423 generates servo information regarding a subsequent track by using the read servo information for reference, and applies a controlling signal for controlling the position of the magnetic head 415 to the VCM driving unit 424 by using an operation program stored in the memory 427.

The VCM driving unit 424 drives the VCM 417 according to the applied controlling signal so as to move an actuator to a position at which the magnetic head 415 can record the servo information regarding the subsequent track. In addition, the servo information generated by the controlling unit 423 is transferred via the read/write channel 422 and the pre amplifier 421 to the magnetic head 415 so that the magnetic head 415 can record information on a magnetic recording medium.

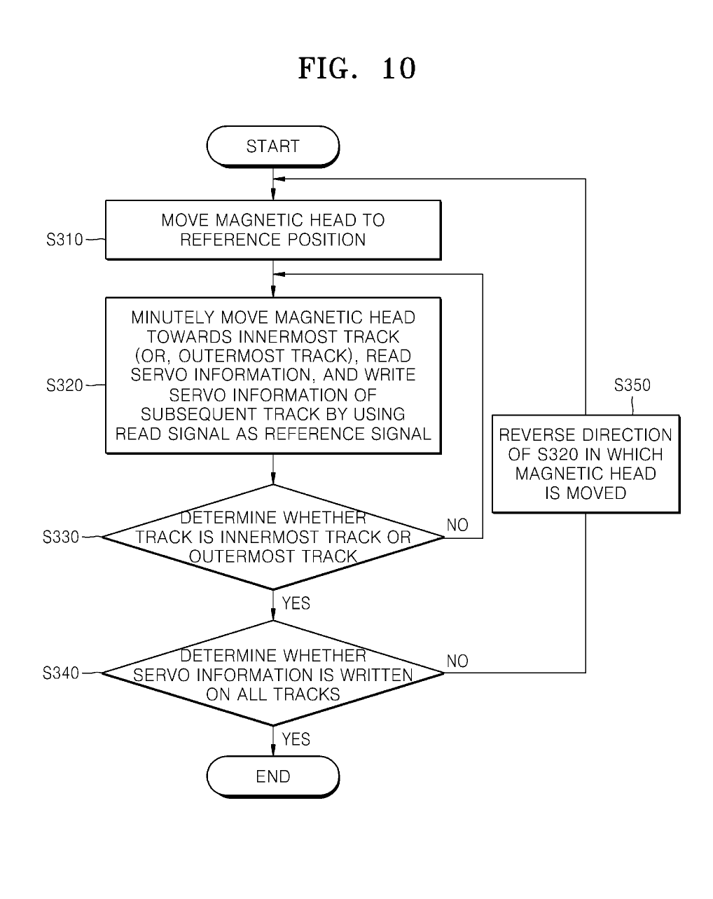

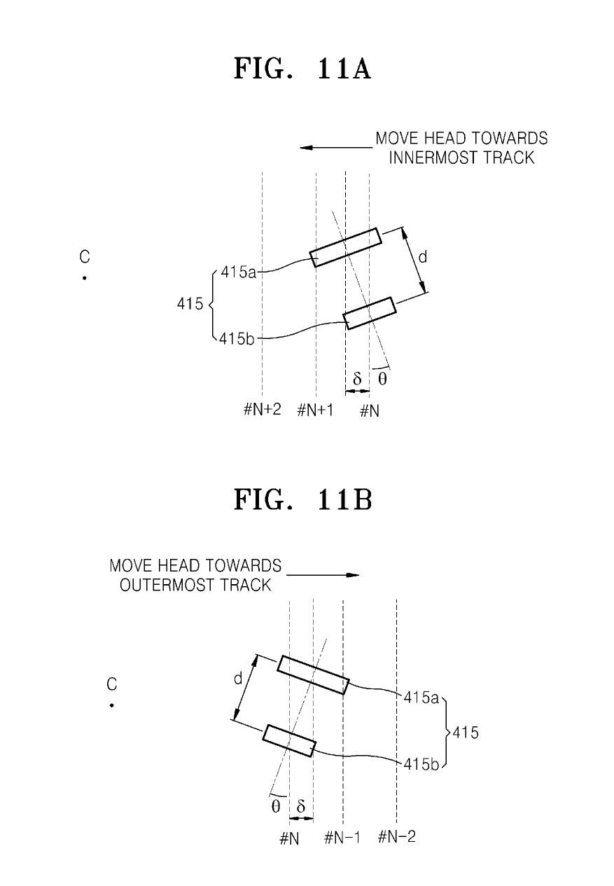

FIG. 10 is a flow chart of a method of self servo writing according to an exemplary embodiment of the present invention. FIGS. 11A and 11B are diagrams for describing directions in which a magnetic head 415 is moved according to skew angles when the method of self servo writing is performed, according to exemplary embodiments of the present invention. Referring to FIGS. 10, 11A and 11B, the method of self servo writing according to the current exemplary embodiment will be described.

The method of self servo writing according to the current exemplary embodiment includes: loading a patterned magnetic recording medium, on which a physical servo pattern is formed on some tracks, in an HDD, and moving a magnetic head 415 to a reference position in which servo information written in the form of the physical servo pattern can be read; minutely moving the magnetic head 415, and writing servo information regarding the other tracks on the corresponding tracks, on which the physical servo pattern is not formed, by using a reproducing signal generated from the physical servo pattern as a reference signal.

For example, when the magnetic recording medium is loaded on the HDD, the magnetic head 415 is moved to the reference position (operation S310). In this regard, the magnetic recording medium may be a patterned magnetic recording medium in which servo information is written on only some tracks of a servo sector in the form of a physical servo pattern. For example, the patterned magnetic recording media (100 of FIG. 1, and 200 of FIG. 5) can be used as the magnetic recording medium according to the current exemplary embodiment. The reference position is a position at which the physical servo pattern is formed. Hereinafter, when the physical servo pattern is assumed to be formed only on a predetermined track, the reference position is referred to as a track #N.

Next, the written servo information is read and simultaneously servo information regarding a subsequent track is recorded using the read servo information as a reference signal, with the magnetic head 415 being moved (operation S320). For example, initially, a track ID #(N+1) or #(N−1) is rendered to a track, on which servo information is not written and which is the closest to the track #N on which the physical servo pattern is formed, by using the servo information regarding the track #N on which the physical servo pattern is formed. Then, servo writing is performed by writing a burst used for following a track #(N+1) or #(N−1). Next, a track ID #(N+2) or #(N−2) is rendered to a track which is the closest to the track #(N+1) or #(N−1) by using the servo information regarding the track #(N+1) or #(N−1) as a reference signal, and then servo writing is performed by writing a burst used for following a track #(N+2) or #(N−2).

The magnetic head 415 is minutely moved in a direction in which an absolute value of a skew angle of the HDD is increased. In particular, the direction is determined according to the sign of the skew angle. This will be described with reference to FIGS. 11A and 11B. In FIGS. 11A and 11B, “C” indicates the center of a patterned magnetic recording medium shaped like a disk. The magnetic head 415 includes a recording head 415a and a reproducing head 415b. The magnetic head 415 is installed at an end of an actuator arm. In addition, the magnetic head 415 faces the patterned magnetic recording medium according to the rotation of the actuator arm, and has a skew angle θ. The skew angle θ is defined by a line connecting the centers of the recording head 415a and the reproducing head 415b and a line parallel to a central line of a track, and is determined according to a track position at which the patterned magnetic recording medium faces the magnetic head 415. The recording head 415a and the reproducing head 415b have a deviation δ defined therebetween in a cross-track direction, according to the skew angle θ and an offset “d” between the recording head 415a and the reproducing head 415b. As illustrated in FIG. 11A, when the recording head 415a is closer to an innermost track than the reproducing head 415b, the sign of the skew angle θ of the magnetic head 415 is assumed to be negative (−). In this case, when the reproducing head 415b reads servo information, which is used as a reference signal, along a central line of a track having a track ID #N, the recording head 415a faces a line of a track that is closer to the innermost track than the track having the track ID #N. That is, in such a position, the magnetic head 415 can write new servo information only on the track that is closer to the innermost track than the track having the track ID #N, which provides the reference signal. Thus, in this case, while the magnetic head 415 is being minutely moved towards the innermost track so that an absolute value of the skew angle θ of the magnetic head 415 may be increased towards a negative (−) direction, servo information regarding a track #(N+1) is written on the track #(N+1) adjacent to the track #N by using the servo information regarding the track #N as a reference signal. Next, while the magnetic head 415 is being further moved towards the innermost track, servo information regarding the track #(N+1) is read, and servo information regarding a track #(N+2) is written on the track #(N+2) that is a subsequent track of the track #(N+1) towards the innermost track by using the read servo information as a reference signal.

As illustrated in FIG. 11B, when the recording head 415a is closer to an outermost track than the reproducing head 415b, the sign of the skew angle θ of the magnetic head 415 is assumed to be positive (+). In this case, when the reproducing head 415b reads servo information, which is used as a reference signal, along a central line of a track having a track ID #N, the recording head 415a faces a line of a track that is closer to the outermost track than the track having the track ID #N. That is, in such a position, the magnetic head 415 can write new servo information only on the track that is closer to the outermost track than the track having the track ID #N, which provides the reference signal. Thus, in this case, while the magnetic head 415 is being minutely moved towards the outermost track so that the skew angle θ of the magnetic head 415 may be increased towards a positive (+) direction, servo information regarding a track #(N−1) is written on the track #(N−1) adjacent to the track #N by using the servo information regarding the track #N as a reference signal. Next, while the magnetic head 415 is being further moved towards the outermost track, servo information regarding the track #(N−1) is read, and servo information regarding a track #(N−2) is written on the track #(N−2) that is a subsequent track of the track #(N−1) towards the outermost track by using the read servo information as a reference signal.

Like this, when the magnetic head 415 is moved in a direction so that the absolute value of the skew angle θ is increased, new servo information can be written on a track on which servo information is not written. In particular, if the sign of the skew angle θ is negative (−), the magnetic head 415 has to be minutely moved towards the innermost track for writing servo information. If the sign of the skew angle θ is positive (+), the magnetic head 415 has to be minutely moved towards the outermost track for writing servo information. Thus, when servo information is to be written on all tracks, a track which provides an initial reference signal and on which the physical servo pattern is formed needs to correspond to a minimum absolute value of the skew angle θ.

In addition, an interval through which the magnetic head 415 is minutely moved is determined according to the skew angle θ and the offset “d” between the recording head 415a and the reproducing head 415b. The interval may be less than half a track so that a reference signal is read by the reproducing head 415b, and simultaneously servo writing is performed by the recording head 415a.

Next, it is determined whether a track on which servo information is written, is the innermost track or the outermost track (operation S330). When it is determined that the track is not the innermost track or the outermost track, a previous operation (operation S320) is again performed. When it is determined that the track is the innermost track or the outermost track, it is determined whether servo information regarding all tracks of the patterned magnetic recording medium is written (operation S340). When it is determined that the servo information regarding all the tracks is written, self servo writing is finished. When it is determined that the servo information regarding all the tracks is not written, a signal value is rendered in order to reverse the direction in which the magnetic head 415 is moved (operation S350), and the magnetic head 415 is moved back to the reference position (operation S310). Next, operations subsequent to operation S320 are performed. At this time, the direction at which the magnetic head is minutely moved is opposite to the direction of the case prior to operation S350. According to the determination of operations S330 and 340, when servo information is written on all the tracks, the self servo writing is finished. According to the above-described operations, the patterned magnetic recording media (100′ of FIG. 4 or 200′ of FIG. 8) in which servo information is written on some tracks of the servo sector in the form of the physical servo pattern and servo information is written on the other tracks of the servo sector in the form of the magnetic servo pattern is formed.

While the patterned magnetic recording medium and a method of writing servo information onto the patterned magnetic recording medium has been particularly shown and described with regard to exemplary embodiments thereof, it will be understood by one of ordinary skill in the art that various changes in form and details may be made therein without departing from the spirit and scope of the present invention as defined by the following claims.

What is claimed is:

1. A patterned magnetic recording medium comprising:
a data sector comprising a plurality of magnetic recording regions spaced apart from one another, wherein the magnetic recording regions constitute a plurality of tracks which are each shaped like a ring; and
a servo sector on which servo information regarding the tracks is to be written along the tracks,
wherein only to a part of the tracks of the servo sector, servo information regarding the part of the tracks is written in the form of a physical servo pattern which is formed by physically patterning a magnetic recording layer.

2. The medium of claim 1, wherein a continuous magnetic recording layer is formed on other tracks apart from the part of tracks of the servo sector.

3. The medium of claim 2, wherein servo information regarding the other tracks is written on the corresponding tracks of the servo sector.

4. The medium of claim 1, wherein the part of the tracks of the servo sector comprises a track corresponding to a minimum absolute value of a skew angle of a hard disk drive (HDD) driving the patterned magnetic recording medium.

5. The medium of claim 1, wherein the patterned magnetic recording medium is a discrete track medium in which the magnetic recording regions are discrete on a track by track basis.

6. The medium of claim 1, wherein the patterned magnetic recording medium is a bit patterned medium in which the magnetic recording regions are discrete on a bit by bit basis.

7. The medium of claim 1, wherein a groove is formed between the magnetic recording regions spaced apart from one another.

8. The medium of claim 7, wherein the groove is filled with a non-magnetic material.

9. A method of self servo writing onto a patterned magnetic recording medium which comprises a data sector comprising a plurality of magnetic recording regions which are spaced apart from one another and constitute a plurality of tracks which are each shaped like a ring, a servo sector on which servo information regarding the tracks is to be written along the tracks, wherein only to a part of the tracks of the servo sector, servo information regarding the part of the tracks is written in the form of a physical servo pattern which is formed by physically patterning a magnetic recording layer, the method comprising:
loading the patterned magnetic recording medium in a hard disk drive (HDD), and moving a magnetic head to a reference position from which the servo information written in the form of the physical servo pattern is capable of being read; and
minutely moving the magnetic head, and writing servo information regarding other tracks apart from the part of the tracks of the servo sector, on the corresponding tracks, on which the physical servo pattern is not formed, by using a reproducing signal generated from the physical servo pattern as a reference signal.

10. The method of claim 9, wherein the minute moving of the magnetic head, comprises:
writing servo information regarding a first track, which is closest to the part of the track of the servo sector, on the first track, by using the reproducing signal generated from the physical servo pattern as a reference signal; and
writing servo information regarding a second track, which is closest to the first track, on the second track, by using a reproducing signal generated from the servo information written on the first track as a reference signal.

11. The method of claim 9, wherein the magnetic head is moved through an interval of less than half a track.

12. The method of claim 9, wherein in the minute moving of the magnetic head, the magnetic head is minutely moved in a direction in which an absolute value of a skew angle of the HDD is increased.

13. The method of claim 12, wherein the part of the tracks of the servo sector of the patterned magnetic recording medium comprises a track corresponding to a minimum absolute value of the skew angle of the HDD.

14. The method of claim 13, wherein if the skew angle is in the range of a negative value to a positive value, the minute moving of the magnetic head comprises:
minutely moving the magnetic head in a direction in which a value of a skew angle is increased, and writing servo information regarding the other tracks on the corresponding tracks of the servo sector, on which the physical servo pattern is not formed;
moving the magnetic head back to the reference position; and
minutely moving the magnetic head in a direction in which a value of a skew angle is reduced, and writing servo information regarding the other tracks on the corresponding tracks of the servo sector, on which the physical servo pattern is not formed.
